(19) United States
(12) Patent Application Publication
(10) Pub. No.: US 2024/0332591 A1
(43) Pub. Date: Oct. 3, 2024

(54) SECONDARY BATTERY AND PRODUCTION METHOD FOR THE SAME

(71) Applicant: HONDA MOTOR CO., LTD., Tokyo (JP)

(72) Inventor: Toshiyuki ARIGA, Saitama (JP)

(21) Appl. No.: 18/586,555

(22) Filed: Feb. 26, 2024

(30) Foreign Application Priority Data
Mar. 29, 2023 (CN) 202310320245.1

(51) Int. Cl. H01M 10/04

(52) U.S. Cl. CPC H01M 10/0431

(57) ABSTRACT

A secondary battery according to the present invention includes an electrode laminate: in which the electrode laminate has positive electrode layers, negative electrode layers, and an elongated separator; the elongated separator includes an insulating porous film and a conductive layer; the elongated separator has an electrode layer accommodating portion with insulating folds folded such that their surfaces on the insulating porous film side are inside and conductive folds folded such that their surfaces on the conductive layer side are inside, alternately overlaid, and a first extension portion extending from one length-directional end portion of the electrode layer accommodating portion; the positive electrode layers and the negative electrode layers are placed in the insulating folds and the conductive folds respectively; and the first extension portion is wound around an outer surface of the electrode layer accommodating portion such that its surface on the insulating porous film side is outside.

This application is based on and claims the benefit of priority from Chinese Patent Application No. CN202310320245.1, filed on 29 Mar. 2023, the content of which is incorporated herein by reference.

### BACKGROUND OF THE INVENTION

### Field of the Invention

The present invention relates to a secondary battery and a production method for the same.

### Related Art

In recent years, research and development on secondary batteries that contribute to energy efficiency have been conducted to allow more people to surely access an affordable, reliable, sustainable, and advanced energy. To improve energy densities of secondary batteries, secondary batteries having a laminated structure with multiple positive electrode layers and negative electrode layers alternately overlaid have been investigated. For the second batteries having this laminated structure, it has been investigated that an elongated separator is folded in a zigzag shape and positive electrode layers and negative electrode layers are alternately overlaid in the folded portions, e.g. for the purpose of suppressing displacement of the positive electrode layers and negative electrode layers (Patent Documents 1 and 2).
Patent Document 1: PCT International Publication No. WO2020/003846
Patent Document 2: PCT International Publication No. WO2020/003847

### SUMMARY OF THE INVENTION

Incidentally, in the technologies regarding secondary batteries, there is a task to achieve a higher capacity. The practical application of lithium metal secondary batteries made of a metallic lithium as a negative electrode active material for the higher capacity of secondary batteries has been desired. However, in a lithium metal secondary battery, a thickness of a negative electrode layer significantly changes due to charge and discharge. Thus, in a lithium metal secondary battery having a laminated structure with multiple positive electrode layers and negative electrode layers alternately overlaid, change in a thickness of a negative electrode layers due to charge and discharge is likely to displace the negative electrode layers and positive electrode layers.

When a lithium metal secondary battery is repeatedly charged and discharged, an SEI layer (solid electrolyte intermediate phase) accumulates on an interface between a current collector and lithium in the negative electrode layer, and a lithium dendrite is easily generated during charging. Once the lithium dendrite is generated, the lithium dendrite may penetrate a separator, resulting in a short circuit between the positive electrode layers and the negative electrode layers. Furthermore, once the lithium dendrite is generated, a density of a metallic lithium layer (negative electrode active material layer) deposited on the negative electrode current collector may decrease, resulting in excessive expansion of the lithium secondary battery during charging.

According to the inventor's investigation, a laminate with a conductive layer laminated on a surface of a porous film is used as a separator, and the conductive layer is placed on the negative electrode layer side, so that it is possible to suppress a short circuit due to the dendrite and decrease in a density of the active material layer of the negative electrode layers during charging in some cases. However, when an elongated separator having a conductive layer on one surface is folded in a zigzag shape and positive electrode layers and negative electrode layers are alternately overlaid in the folded portions, the positive electrode layers and the conductive layer of the elongated separator may come into contact with each other, resulting in a short circuit between the positive electrode layers and the negative electrode layers.

The present invention has been made in view of the above-mentioned circumstances, and an object of the present invention is to provide a secondary battery with positive and negative electrode layers that are less likely to be displaced even when a thickness of the negative electrode layers is significantly changed due to charge and discharge, and provide a production method thereof. In particular, an object of the present invention is to provide a secondary battery with positive and negative electrode layers that are less likely to be displaced even when using a separator having a conductive layer on one surface and are less likely to cause a short circuit, and provide a production method thereof. Consequently, the objects contribute to improvement of energy efficiency.

The present inventors have found that it is effective for solving the above-mentioned problems to dispose an extension portion of an elongated separator on an end portion of an electrode layer accommodating portion with the elongated separator folded in a zigzag shape, where positive and negative electrode layers are placed, and to wind the extension portion around an outer surface of the electrode layer accommodating portion. This finding has completed the present invention. Thus, the present invention provides the following aspects.

(1) A secondary battery including an electrode laminate, an electrolytic solution, and an exterior body accommodating the electrode laminate and the electrolytic solution; the electrode laminate having positive electrode layers, negative electrode layers, and an elongated separator; the elongated separator including an insulating porous film and a conductive layer provided on one surface of the insulating porous film; the elongated separator having an electrode layer accommodating portion with insulating folds folded along a length direction such that their surfaces on the insulating porous film side are inside and conductive folds folded along the length direction such that their surfaces on the conductive layer side are inside, alternately overlaid, and a first extension portion extending from one length-directional end portion of the electrode layer accommodating portion; the positive electrode layers and the negative electrode layers being placed in the insulating folds and the conductive folds respectively so as to be opposed to each other; and the first extension portion being wound around an outer surface of the electrode layer accommodating portion such that its surface on the insulating porous film side is outside.

In the secondary battery according to (1), since the first extension portion is wound around the outer surface of the electrode layer accommodating portion, the positive and negative electrode layers are less likely to be displaced even when a thickness of the negative electrode layers is significantly changed due to charge and discharge. Since the conductive layer of the elongated separator is placed on the negative electrode layer side, it is possible to suppress a short circuit due to dendrites and decrease in a density of a negative electrode active material layer of the negative electrode layers during charging. Furthermore, the insulating porous film of the elongated separator is placed on the positive electrode layer side, and the first extension portion is wound around the electrode layer accommodating portion such that the surface of the electrode layer accommodating portion on the insulating porous film side is outside, and therefore the conductive layer of the elongated separator and the positive electrode layers are less likely to come into contact with each other. Thus, a short circuit between the positive electrode layers and the negative electrode layers is less likely to occur.

(2) The secondary battery according to (1), including a second extension portion extending from the other length-directional end portion of the electrode layer accommodating portion, in which the second extension portion extends such that the surface of the insulating porous film is in contact with ends of the conductive folds.

In the secondary battery according to (2), since the second extension portion is in contact with the ends of the conductive folds, i.e. the surface of the insulating porous film is in contact with the openings of the insulating folds, the conductive layer of the elongated separator and the positive electrode layers are less likely to come into contact with each other, and thereby a short circuit between the positive electrode layers and the negative electrode layers is less likely to occur.

(3) The secondary battery according to (1) or (2), in which each conductive fold has an extended portion with a fold end extended, and the extended portion is bent toward the positive electrode layer side.

In the secondary battery according to (3), when the extended portions of the conductive folds are bent toward the positive electrode layer side, end portions of the positive electrode layers located on the opening side of the insulating folds are surrounded by the insulating porous film, thereby the conductive layer of the elongated separator and the positive electrode layers are even less likely to come into contact with each other, and a short circuit between the positive electrode layers and the negative electrode layers is even less likely to occur.

(4) The secondary battery according to any one of (1) to (3), including a positive electrode terminal electrically connected to the positive electrode layers and having at least a part exposed to the outside, and a negative electrode terminal electrically connected to the negative electrode layers and having at least a part exposed to the outside, in which the positive electrode terminal and the negative electrode terminal are arranged along a direction orthogonal to the length direction of the elongated separator.

In the secondary battery according to (4), since the positive electrode terminal and the conductive layer of the elongated separator are less likely to come into contact with each other, a short circuit between the positive electrode layers and the negative electrode layers is less likely to occur.

(5) The secondary battery according to any one of (1) to (4), in which a negative electrode active material is metallic lithium.

In the secondary battery according to (5), since the negative electrode active material is metallic lithium, a higher capacity can be achieved.

(6) A production method for a secondary battery, including: preparing an elongated separator having an electrode layer accommodating portion formed by folding, in a zigzag shape, a part of an elongated laminated sheet including an insulating porous film and a conductive layer placed on one surface of the insulating porous film in such a way that insulating folds folded along a length direction such that a surface on the insulating porous film side is inside and conductive folds folded along a length direction such that a surface on the conductive layer side is inside are alternately overlaid, and a first extension portion extending from one length-directional end portion of the electrode layer accommodating portion; placing positive electrode layers and negative electrode layers on the insulating folds and the conductive folds respectively so as to be opposed to each other; and winding the first extension portion around an outer surface of the electrode layer accommodating portion such that the surface on the insulating porous film side is outside.

In the production method for the secondary battery according to (6), since the method includes winding the first extension portion of the elongated separator around the outer surface of the electrode layer accommodating portion, a secondary battery with positive and negative electrode layers that are less likely to be displaced even when a thickness of the negative electrode layers is significantly changed due to charge and discharge can be advantageously produced for industrial applications. Since, in the obtained secondary battery, the conductive layer of the elongated separator is placed on the negative electrode layer side, it is possible to suppress a short circuit due to dendrites and decrease in a density of a negative electrode active material layer of the negative electrode layers during charging. Furthermore, in the obtained secondary battery, the insulating porous film of the elongated separator is placed on the positive electrode layer side, and the first extension portion is wound around the electrode layer accommodating portion such that the surface of the electrode layer accommodating portion on the insulating porous film side is outside, and therefore the conductive layer of the elongated separator and the positive electrode layers are less likely to come into contact with each other. Thus, in the obtained secondary battery, a short circuit between the positive electrode layers and the negative electrode layers is less likely to occur.

(7) A secondary battery including an electrode laminate, an electrolytic solution, and an exterior body accommodating the electrode laminate and the electrolytic solution; the electrode laminate having positive electrode layers, negative electrode layers, and an elongated separator; the elongated separator having an electrode layer accommodating portion with two or more folds folded in a zigzag shape along a length direction and an extension portion connected to a length-directional end portion of the electrode layer accommodating portion; the positive electrode layers and the negative electrode layers being placed in the respective folds so as to be opposed to each other; and the extension portion being wound around an outer surface of the electrode layer accommodating portion.

In the secondary battery according to (7), since the first extension portion is wound around the outer surface of the electrode layer accommodating portion, the positive and negative electrode layers are less likely to be displaced even when a thickness of the negative electrode layers is significantly changed due to charge and discharge.

The present invention makes it possible to provide a secondary battery with positive and negative electrode layers that are less likely to be displaced even when a thickness of the negative electrode layers is significantly changed due to charge and discharge, and provide a production method thereof. In particular, the present invention makes it possible to provide a secondary battery with positive and negative electrode layers that are less likely to be displaced even when using a separator having a conductive layer on one surface and are less likely to cause a short circuit, and provide a production method thereof.

### BRIEF DESCRIPTION OF THE DRAWINGS

FIG. 1 is a perspective view of a secondary battery according to the first embodiment of the present invention;

FIG. 2 is a sectional view taken along line II-II in FIG. 1;

FIG. 3 is a sectional view taken along line III-III in FIG. 1;

FIG. 4 is a sectional view of a separator for the secondary battery according to the first embodiment of the present invention;

FIG. 5 is a sectional view illustrating a state in which positive electrode layers and negative electrode layers are placed in an electrode layer accommodating portion of an elongated separator in producing the secondary battery according to the first embodiment of the present invention;

FIG. 6 is a sectional view illustrating a variant example of the secondary battery according to the first embodiment of the present invention;

FIG. 7 is a sectional view illustrating a state in which the positive electrode layers and the negative electrode layers are placed in the electrode layer accommodating portion of the elongated separator in producing the secondary battery according to the variant example; and

FIG. 8 is a sectional view of a secondary battery according to the second embodiment of the invention.

### DETAILED DESCRIPTION OF THE INVENTION

The embodiments of the present invention will be explained below with reference to the figures. However, the following embodiments are intended to merely illustrate the present invention, and the present invention is not limited to the following embodiments.

### First Embodiment

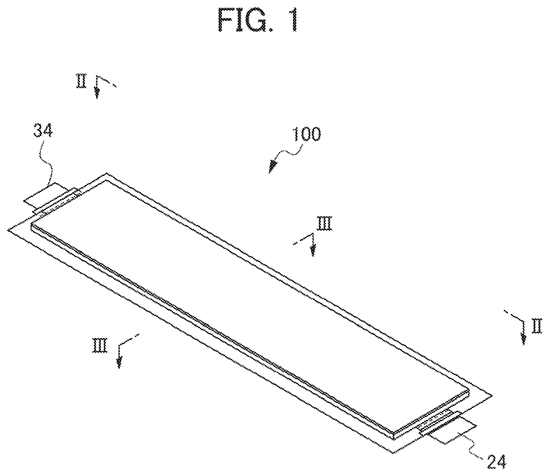

FIG. 1 is a perspective view of a secondary battery according to the first embodiment of the present invention.

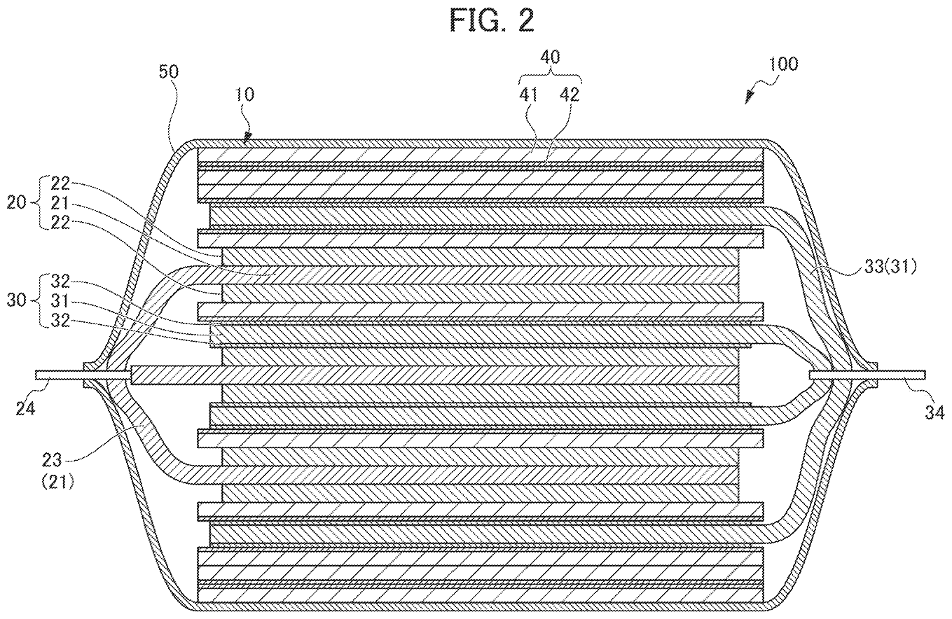

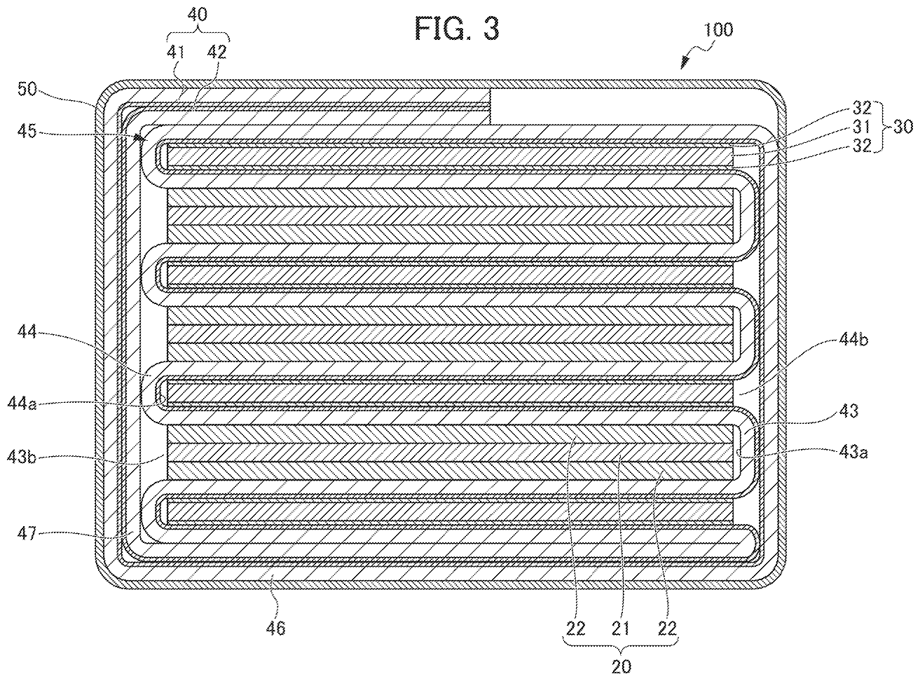

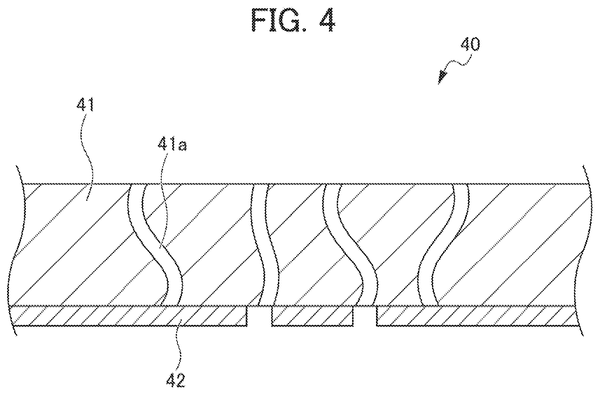

FIG. 2 is a sectional view taken along line II-II in FIG. 1, and FIG. 3 is a sectional view taken along line III-III in FIG. 1. FIG. 4 is a sectional view of a separator for the secondary battery according to the first embodiment of the present invention.

A secondary battery 100 according to this embodiment includes an electrode laminate 10 having positive electrode layers 20, negative electrode layers 30, and an elongated separator 40 placed between the positive electrode layers 20 and the negative electrode layers 30; an electrolytic solution (not illustrated); and an exterior body accommodating the electrode laminate 10 and the electrolytic solution. Each positive electrode layer 20 includes a positive electrode current collector 21 and positive electrode active material layers 22 laminated on both sides of the positive electrode current collector 21. Each negative electrode layer 30 includes a negative electrode current collector 31 and lithium foils 32 laminated on both sides of the negative electrode current collector 31. The secondary battery 100 is a lithium metal secondary battery. The lithium metal secondary battery is a secondary battery made of metallic lithium as the negative electrode active material, in which, lithium is released from the positive electrode active material layers 22 during charging, and lithium is deposited on the surfaces of the lithium foils 32 to generate metallic lithium layers. Thereby, a thickness of the negative electrode layers 30 increases during charging. On the other hand, during discharging, lithium is released from the metallic lithium layers and occluded into the positive electrode active material layers 22. Thereby, the thickness of the negative electrode layers 30 decreases during discharging. Thus, the thickness of the negative electrode layers 30 is significantly changed due to charge and discharge. The secondary battery 100 illustrated in FIG. 1 to FIG. 3 is in a discharging state.

The secondary battery 100 further includes a positive electrode terminal 24 and a negative electrode terminal 34 that are placed in the exterior body 50, a positive electrode lead wire 23 electrically connecting between the positive electrode layers 20 (positive electrode current collector 21) and the positive electrode terminal 24, and a negative electrode lead wire 33 electrically connecting between the negative electrode layers 30 (negative electrode current collector 31) and the negative electrode terminal 34. A part of the positive electrode terminal 24 and a part of the negative electrode terminal 34 are exposed to the outside. The positive electrode terminal 24 is placed along a width direction of the elongated separator 40 (a direction perpendicular to the length direction of the elongated separator 40), and the negative electrode terminal 34 is placed so as to be opposed to the positive electrode terminal 24 via the electrode laminate 10 therebetween.

The elongated separator 40 has an electrode layer accommodating portion 45 with insulating folds 43 and conductive folds 44 alternately overlaid. The insulating folds 43 are folded along the length direction such that their surfaces on the insulating porous film 41 side are inside. Each insulating fold 43 has a fold end 43a and an opening 43b located on the opposite side to the end 43a. The conductive folds 44 are folded along the length direction such that their surfaces on the conductive layer 42 side are inside.

The elongated separator 40 includes a first extension portion 46 extending from an upper length-directional end portion of the electrode layer accommodating portion 45, and a second extension portion 47 extending from a lower length-directional end portion of the electrode layer accommodating portion 45. The first extension portion 46 is wound around an outer surface of the electrode layer accommodating portion 45 such that the surface of the first extension portion 46 on the insulating porous film 41 side is outside. The number of turns of the first extension portion 46 is e.g. within a range of 1 to 3. The second extension portion 47 extends such that the surface of the insulating porous film 41 is in contact with fold ends 44a of the conductive folds 44 i.e. the openings 43b of the insulating folds 43.

The positive electrode layers 20 and the negative electrode layers 30 are placed in the insulating folds 43 and the conductive folds 44 respectively, so as to be opposed to each other. The negative electrode layers 30 are in contact with the conductive layer 42 of the elongated separator 40, and the positive electrode layers 20 are in contact with the insulating porous film 41 of the elongated separator 40.

The material for the positive electrode current collector 21 is not particularly limited and can be e.g. aluminum. The material for the positive electrode lead wire 23 may be the same as or different from that for the positive electrode current collector 21. The positive electrode lead wire 23 may be integrally connected with the positive electrode current collector 21. In this embodiment, the positive electrode lead wire 23 is formed by extending the positive electrode current collector 21 and integrally connected with the positive electrode current collector 21. The material for the positive electrode terminal 24 may be the same as or different from that for the positive electrode lead wire 23. The positive electrode terminal 24 may be integrally connected with the positive electrode lead wire 23. In this embodiment, the positive electrode terminal 24 and the positive electrode lead wire 23 are individually separate components and electrically connected to each other.

The positive electrode active material layer 22 includes a positive electrode active material. Examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), heteroelement-substituted Li—Mn spinel represented by Li₁₊ₓMn_{2-x-y}M_{y}O₄ (x+y=2, M is at least one selected from Al, Mg, Co, Fe, Ni, and Zn), lithium titanate (oxides containing Li and Ti), and metallic lithium phosphate (LiMPO₄, M is at least one selected from Fe, Mn, Co, and Ni). The positive electrode active material layer 22 may contain various additives as materials for the positive electrode active material layer, such as binders and conductive assistants.

The material for the negative electrode current collector 31 is not particularly limited and can be e.g. copper. The material for the negative electrode lead wire 33 may be the same as or different from that for the negative electrode current collector 31. The negative electrode lead wire 33 may be integrally connected with the negative electrode current collector 31. In this embodiment, the negative electrode lead wire 33 is formed by extending the negative electrode current collector 31 and integrally connected with the negative electrode current collector 31. The material for the negative electrode terminal 34 may be the same as or different from that for the negative electrode lead wire 33. The negative electrode terminal 34 may be integrally connected with the negative electrode lead wire 33. In this embodiment, the negative electrode terminal 34 and the negative electrode lead wire 33 are individually separate components and electrically connected to each other.

The elongated separator 40 includes the insulating porous film 41, and the conductive layer 42 laminated on the surface of the insulating porous film 41 on the negative electrode layer 30 side. The conductive layer 42 need not be laminated over the entire insulating porous film 41. The conductive layer 42 may be laminated so as to cover some of pore portions 41a of the insulating porous film 41, as illustrated in FIG. 4.

As the insulating porous film 41, a known film used as a separator for secondary batteries can be used, such as a porous sheet and a non-woven sheet. Examples of the material for the porous sheet include polyolefin such as polyethylene and polypropylene, aramid, polyimide, and fluororesin. Examples of the material for the nonwoven sheet include a glass fiber and a cellulose fiber. A thickness of the insulating porous film 41 is, but not particularly limited to, preferably 10 μm or more from the viewpoint of blocking lithium metal dendrites, and preferably 15 μm or less from the viewpoint of reducing the resistance in the battery. The thickness of the insulating porous film 41 is more preferably within a range of 10 to 12 μm. An air permeability of the insulating porous film 41 is, but not particularly limited to, preferably 200 sec/100 mL or lower, more preferably 150 sec/100 mL or lower from the viewpoint of reducing the resistance in the battery. A porosity of the insulating porous film 41 is, but not particularly limited to, preferably within a range of 40 to 60% from the viewpoint of uniform diffusion of lithium in the elongated separator 40 and strength of the elongated separator 40.

The conductive layer 42 has an electrical conductivity within a range of 1.0×10¹ to 1.0×10⁵ S/cm without particular limitation. If the conductive layer 42 has an electrical conductivity of 1.0×10¹ S/cm or higher, lithium can be deposited on the surface of the conductive layer 42, and lithium dendrites can be prevented from growing on the positive electrode layer 20 side to cause a short circuit. If the conductive layer 42 has an electrical conductivity of 1.0×10⁵ S/cm or lower, lithium can be uniformly deposited on the surface of the conductive layer 42.

The conductive layer 42 is in electrical contact with either the negative electrode layers 30 or metallic lithium deposited on the negative electrode layers 30 in both discharged and charged states. Thereby, potentials of the conductive layer 42 and the negative electrode current collector 31 are the same, and therefore lithium can be more evenly deposited between the conductive layer 42 of the elongated separator 40 and the lithium foil 32.

The conductive layer 42 may have an electrical conductivity lower than that of the negative electrode current collector 31, i.e. the negative electrode current collector 31 may have an electrical conductivity higher than that of the conductive layer 42. When the negative electrode current collector 31 has an electrical conductivity higher than that of the conductive layer 42, lithium can be prevented from being concentratively deposited on the insulating porous film 41 side of the conductive layer 42, and damage of the conductive layer 42 through shape change due to concentrated deposition of lithium can be suppressed. The conductive layer 42 may have tenth to one-hundredth the electrical conductivity of the negative electrode current collector 31.

A peel strength of the conductive layer 42 from the insulating porous film 41 is, but not particularly limited to, preferably 10 N/m or higher, more preferably 30 N/m or higher. When the peel strength of the conductive layer 42 is as high as the above value, the conductive layer 42 stably acts for a long period of time, resulting in a longer charge and discharge cycle life.

The conductive layer 42 may have a surface resistivity of 200 Ω/cm² or lower.

The conductive layer 42 may have a thickness within a range of 0.01 to 5 μm. If the conductive layer 42 has a thickness of 0.01 μm or more, the aforementioned effects of the conductive layer 42 can be exhibited. If the conductive layer 42 has a thickness of 5 μm or less, reduction in the energy density due to the conductive layer 42 can be suppressed.

Examples of the material for the conductive layer 42 include conductive materials such as metals and carbon nanotubes (CNT). Examples of the metals include Cu, Zn, Ti, and Sn. These conductive materials may be used alone or in combination of two or more types.

Examples of a coating method for forming the conductive layer 42 on the insulating porous film 41 include, but are not limited to, a sputtering method and an application method. Examples of the sputtering method include a direct current (DC) sputtering method and a radio frequency (RF) sputtering method. In the application method, a coating liquid with the material for the conductive layer 42 being dispersed is applied on the surface of the insulating porous film 41 and dried.

The electrolytic solution contains an organic solvent and an electrolyte. Examples of the organic solvent include cyclic carbonates, chain carbonates, cyclic ethers, chain ethers, hydrofluoroethers, aromatic ethers, sulfones, cyclic esters, chain carboxylic acid esters, and nitriles. Examples of the cyclic carbonates include ethylene carbonate, propylene carbonate, vinylene carbonate, and fluoroethylene carbonate. Examples of the chain carbonates include dimethyl carbonate, diethyl carbonate, and ethyl methyl carbonate. Examples of the cyclic ethers include tetrahydrofuran, 2-methyltetrahydrofuran, tetrahydropyran, 1,3-dioxolan, and 4-methyl-1,3-dioxolan. Examples of the chain ethers include 1,2-dimethoxyethane, 1,2-diethoxyethane, ethoxymethoxyethane, and diethyl ether. Examples of the hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane. Examples of the aromatic ethers include anisole. Examples of the sulfones include sulfolane and methylsulfolane. Examples of the cyclic esters include γ-butyrolactone. Examples of the chain carboxylic acid esters include acetic acid ester, butyric acid ester, and propionic acid ester. Examples of the nitriles include acetonitrile and propionitrile. The organic solvents may be used alone or in combination of two or more types.

The electrolyte is a source of lithium ions as a charge transfer medium and contains lithium salts. Examples of the lithium salts include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈. The lithium salts may be used alone or in combination of two or more types. The concentration of the electrolyte is e.g. within a range of 1.5 to 4.0 mol/L.

The exterior body 50 is configured to be expandable and contractable along with changes in the thickness of the electrode laminate 10 (in particular, changes in the thickness of the negative electrode layers 30) due to charge and discharge. Examples of the material for the exterior body 50 include a laminate film. Examples of the laminate film include a three-layer laminated film including an inner resin layer, a metal layer, and an outer resin layer laminated in this order from the inside. Examples of the material for the inner and outer resin layers include thermoplastic resins such as polyethylene terephthalate (PET), polyamide (nylon), and polypropylene (PP). Examples of the material for the metal layer include aluminum.

Next, a production method for the solid secondary battery 100 according to the first embodiment will be explained. The electrode laminate 10 can be produced e.g. by a method including preparing an elongated separator, placing electrode layers, and winding the elongated separator.

In the elongated separator-preparing step, the elongated separator 40 including the electrode layer accommodating portion 45, the first extension portion 46, and the second extension portion 47 is prepared. The elongated separator 40 can be prepared by folding, in a zigzag shape, a central part of the elongated laminated sheet including the insulating porous film 41 and the conductive layer 42 placed on one surface of the insulating porous film 41 in such a way that the insulating folds 43 folded along the length direction such that their surfaces on the insulating porous film 41 side are inside and conductive folds 44 folded along the length direction such that their surfaces on the conductive layer 42 side are inside are alternately overlaid.

In the electrode layer-placing step, the positive electrode layers 20 and the negative electrode layers 30 are placed in the insulating folds 43 and the conductive folds 44 respectively so as to be opposed to each other. The positive electrode layers 20 can be placed by inserting the positive electrode layers 20 into the insulating folds 43 from the openings 43b of the insulating folds 43. The negative electrode layers 30 can be placed by inserting the negative electrode layers 30 into the conductive folds 44 from the openings 44b of the conductive folds 44. The elongated separator-preparing step and the electrode layer-placing step may be simultaneously proceeded in parallel. For example, a manipulation may be performed, in which the positive electrode layers 20 are placed on the surface of the elongated laminated sheet on the insulating porous film 41 side, then the elongated laminated sheet is folded along the length direction such that its surface on the insulating porous film 41 side is inside, subsequently the negative electrode layers 30 are placed on the surface of the elongated laminated sheet on the conductive layer 42 side, then the elongated laminated sheet is folded along the length direction such that its surface on the conductive layer 42 side is inside.

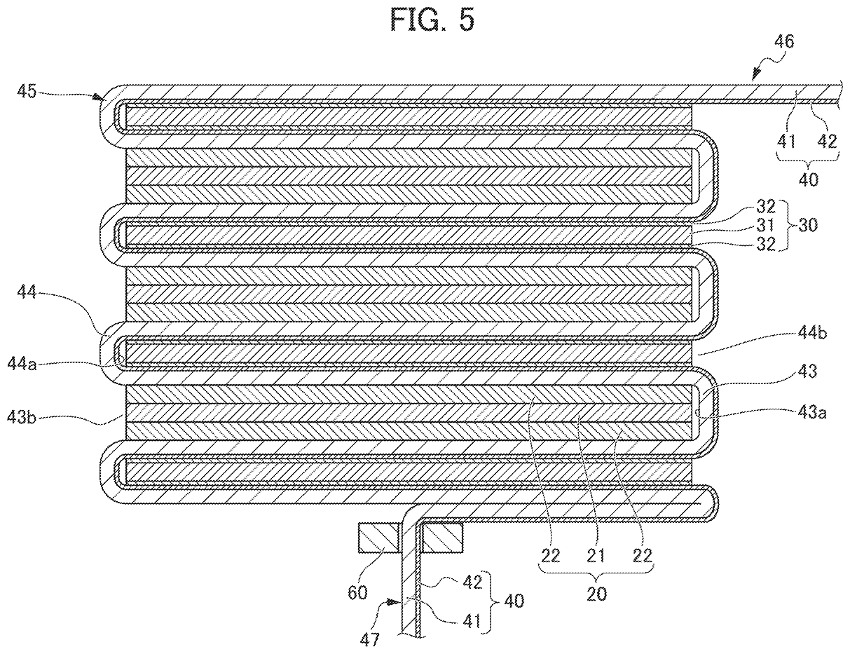

FIG. 5 is a sectional view illustrating a state in which the positive electrode layers and the negative electrode layers are placed in the electrode layer accommodating portion of the elongated separator according to the first embodiment. The second extension portion 47 of the elongated separator 40 is fixed by a chuck 60. The positive electrode layers 20 and the negative electrode layers 30 are alternately arranged in the electrode layer accommodating portion 45 folded in a zigzag shape. In the electrode layer accommodating portion 45, the positive electrode layers 20 are placed in the insulating folds 43, and the negative electrode layers 30 are placed in the conductive folds 44. The first extension portion 46 is formed on an end of the electrode layer accommodating portion 45.

In the elongated separator-winding step, the first extension portion 46 is wound around the outer surface of the electrode layer accommodating portion 45 of the elongated separator 40 such that the surface of the first extension portion 46 on the insulating porous film 41 side is outside. In the case of the elongated separator illustrated in FIG. 5, the first extension portion 46 is wound around the outer surface of the electrode layer accommodating portion 45 such that the conductive layer 42 is inside (clockwise in FIG. 5). When winding the first extension portion 46, the chuck 60 is removed, and the first extension portion 46 and the second extension portion 47 are overlaid such that the conductive layer 42 of the first extension portion 46 and the conductive layer 42 of the second extension portion 47 are in contact with each other. Thereby, the surface of the insulating porous film 41 of the second extension portion 47 comes into contact with the openings 43b of the insulating folds 43 where the positive electrode layers 20 are placed. Prior to the elongated separator-winding step, the surface of the second extension portion of the elongated separator 40 on the insulating porous film 41 side may be brought into contact with the ends of the conductive folds 44.

The secondary battery 100 can be produced as follows. The positive electrode current collector 21 of the positive electrode layers 20 of the obtained electrode laminate 10 is connected with the positive electrode terminal 24 via the positive electrode lead wire 23, and the negative electrode current collector 31 of the negative electrode layers 30 is connected with the negative electrode terminal 34 via the negative electrode lead wire 33. Subsequently, the electrode laminate 10 is accommodated in the exterior body 50 such that a part of the positive electrode terminal 24 and a part of the negative electrode terminal 34 protrude, an electrolytic solution is injected to the exterior body 50, and then the exterior body 50 is sealed.

In the secondary battery 100 according to the first embodiment configured as described above, the first extension portion 46 of the elongated separator 40 is wound around the outer surface of the electrode layer accommodating portion 45, and therefore the positive electrode layers 20 and the negative electrode layers 30 are less likely to be displaced even if the thickness of the negative electrode layers 30 is significantly changed due to charge and discharge. Since the conductive layer 42 of the elongated separator 40 is placed on the negative electrode layer 30 side, it is possible to suppress a short circuit due to dendrites and decrease in the density of the negative electrode active material layer of the negative electrode layers 30 during charging. The insulating porous film 41 of the elongated separator 40 is placed on the positive electrode layer 20 side, the first extension portion 46 is wound around the electrode layer accommodating portion 45 such that the surface of the electrode layer accommodating portion 45 on the insulating porous film 41 side is outside, and therefore the conductive layer 42 of the elongated separator 40 and the positive electrode layers 20 are less likely to come into contact with each other. Consequently, a short circuit between the positive electrode layers 20 and the negative electrode layers 30 is less likely to occur.

Furthermore, in the secondary battery 100 according to the first embodiment, the second extension portion 47 is in contact with the ends 44a of the conductive folds 44, i.e. the surface of the insulating porous film 41 is in contact with the openings 43b of the insulating folds 43, therefore the conductive layer 42 and the positive electrode layers 20 are less likely to come into contact with each other, and a short circuit between the positive electrode layers 20 and the negative electrode layers 30 is less likely to occur. Note that, unless the openings 43b of the insulating folds 43 are in contact with the conductive layer, the second extension portion 47 need not be extended such that the surface of the insulating porous film 41 is in contact with the ends 44a of the conductive folds 44.

In the secondary battery 100 according to the first embodiment, since the positive electrode terminal 24 is arranged along a direction perpendicular to the length direction of the elongated separator 40, the positive electrode terminal 24 and the conductive layer 42 are less likely to come into contact with each other. Thereby, a short circuit between the positive electrode layers 20 and the negative electrode layers 30 is less likely to occur. In the secondary battery 100 according to the first embodiment, even if the negative electrode active material is metallic lithium and the thickness of the negative electrode layers is significantly changed due to charge and discharge, the positive electrode layers and negative electrode layers are less likely to be displaced, and a higher capacity can be achieved.

In the production method for the secondary battery 100 according to the first embodiment, the secondary battery 100 can be advantageously manufactured for industrial applications.

In the secondary battery 100 according to the first embodiment, the folds of the electrode layer accommodating portion 45 of the elongated separator 40 are spaced at equal intervals, and a distance from the end 43a to the opening 43b in the insulating fold 43 and a distance from the end 44a to the opening 44b in the conductive fold 44 are the same. The intervals between the folds of the electrode layer accommodating portion 45 are not necessarily equal. For example, the distance from the fold end 44a to the opening 44b in the conductive fold 44 may be extended to be longer than the distance from the fold end 43a to the opening 43b in the insulating fold 43. An example of a secondary battery, in which the fold ends 44a of the conductive folds 44 are extended, will be explained below.

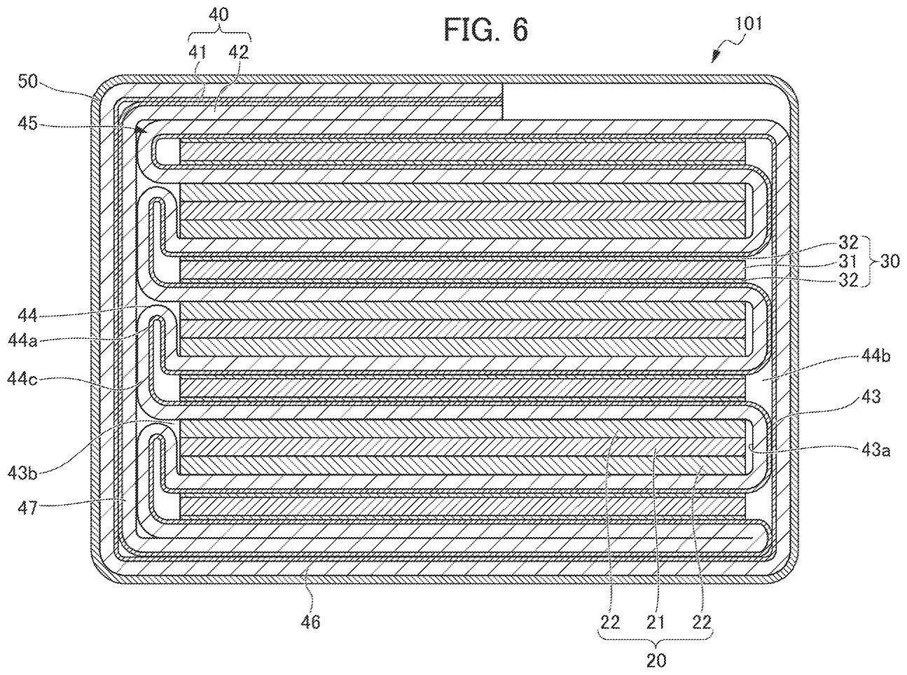

FIG. 6 is a sectional view illustrating a variant example of the secondary battery according to the first embodiment of the present invention, corresponding to the sectional view in FIG. 3. A secondary battery 101 illustrated in FIG. 6 is the same as the secondary battery 100 described above, except that the fold ends 44a of the conductive folds 44 have extended portions 44c. For this reason, the same components as those of the secondary battery 100 are marked with the same symbols as in the secondary battery 100, and their detailed descriptions are omitted.

The extended portions 44c of the conductive folds 44 are bent along the longitudinal-directional end side of the first extension portion toward the opening 43b side (positive electrode layer 20 side) of the insulating folds 43. The extended portions 44c of the conductive folds 44 have the insulating porous film 41 on the outside. Thus, when the extended portions 44c of the conductive folds 44 are bent toward the positive electrode layer 20 side, the end portions of the positive electrode layers 20 placed in the insulating folds 43 are surrounded by the insulating porous film 41, and thereby the conductive layer 42 of the elongated separator 40 and the positive electrode layers 20 are even less likely to come into contact with each other. Consequently, a short circuit between the positive electrode layers 20 and the negative electrode layers 30 is less likely to occur.

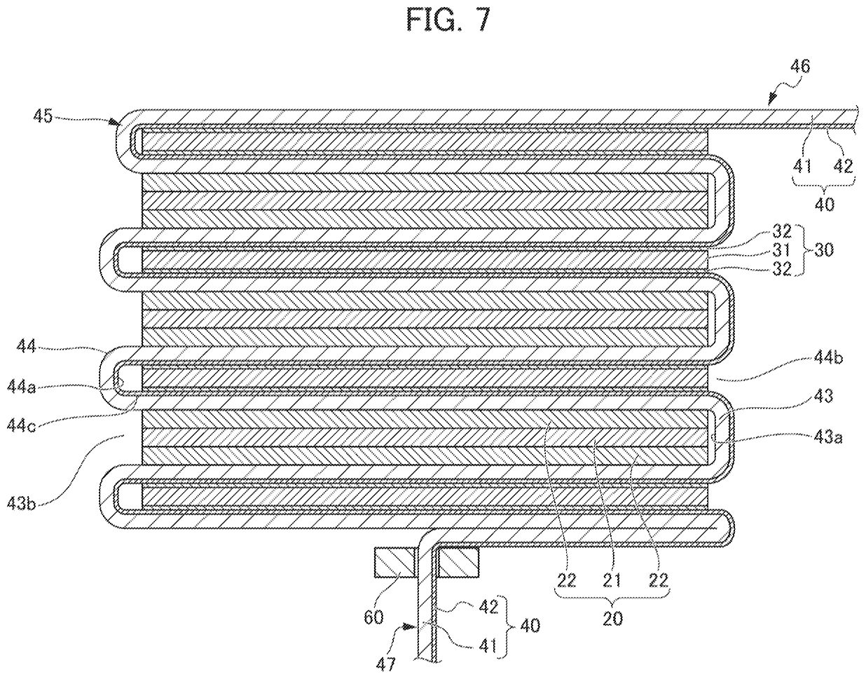

The secondary battery 101 can be produced by folding the elongated separator in a zigzag shape such that the conductive folds 44 are longer than the insulating folds 43 in the elongated separator-preparing step. FIG. 7 is a sectional view illustrating a state in which the positive electrode layers and the negative electrode layers are placed in the electrode layer accommodating portion of the elongated separator according to the variant example. The second extension portion 47 of the elongated separator 40 is fixed by a chuck 60. In the electrode layer accommodating portion 45 folded in a zigzag shape, the positive electrode layers 20 are placed in the insulating folds 43, and the negative electrode layers 30 are placed in the conductive folds 44. The ends 44a of the conductive folds 44 are formed into the extended portions 44c. The negative electrode layers 30 are not provided on the extended portions 44c, and the extended portions 44c are configured to be bendable. The first extension portion 46 is formed on the end of the electrode layer accommodating portion 45. In the elongated separator-winding step, the first extension portion 46 is wound around the outer surface of the electrode layer accommodating portion 45 such that the conductive layer 42 is inside (clockwise in FIG. 7). When winding the first extension portion 46, the extended portions 44c of the conductive folds 44 are bent toward the opening 43b side of the insulating folds 43.

In the secondary battery 101 according to the variant example, the end portions of the positive electrode layers 20 are surrounded by the insulating porous film 41 by the extended portions 44c of the conductive folds 44, and therefore the second extension portion 47 may be shortened compared to the second battery 100 according to the aforementioned embodiment in which the end portions of the positive electrode layers 20 are surrounded by the insulating porous film 41 by the second extension portion 47, or the second extension portion 47 may be omitted.

### Second Embodiment

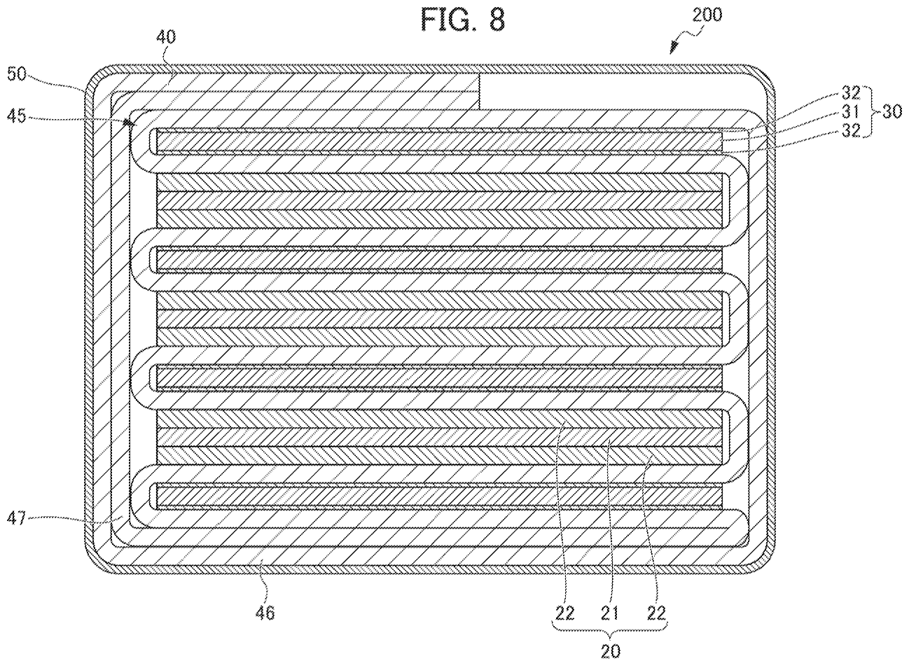

FIG. 8 is a sectional view of a secondary battery according to the second embodiment of the present invention, corresponding to the sectional view of the secondary battery according to the first embodiment in FIG. 3

A secondary battery 200 according to the second embodiment is the same as the secondary battery 100 according to the first embodiment except that the elongated separator 40 has no conductive layer. For this reason, the same components as those of the secondary battery 100 are marked with the same symbols as in the secondary battery 100, and their detailed descriptions are omitted.

In the secondary battery 200 according to the second embodiment, the electrode layer accommodating portion 45 of the elongated separator 40 has folds folded in a zigzag shape along the length direction, and the positive electrode layers 20 and the negative electrode layers 30 are placed in the respective folds so as to be opposed to each other. The first extension portion 46 is wound around the outer surface of the electrode layer accommodating portion 45. The second extension portion 47 is extended so as to be in contact with openings b of the folds where the positive electrode layers 20 are placed.

In the secondary battery 200 according to the second embodiment, the first extension portion 46 of the elongated separator 40 is wound around the outer surface of the electrode layer accommodating portion 45, and therefore the positive electrode layers 20 and the negative electrode layers 30 are less likely to be displaced even if the thickness of the negative electrode layers 30 is significantly changed due to charge and discharge, like the secondary battery 100 according to the first embodiment.

Although the preferable embodiments of the present invention have been described above, the present invention is not limited to the above embodiments and can be modified as appropriate. For example, in the secondary batteries according to the second embodiments, the negative electrode layers 30 include the metallic lithium layer deposited as the negative electrode active material layer during charging, but the negative electrode active material layer is not limited to this metallic lithium layer. A layer including a negative electrode active material that occludes lithium during charging and releases lithium during discharging may be used as the negative electrode active material layer. Examples of the negative electrode active material include lithium transition metal oxides such as lithium titanate, transition metal oxides such as TiO₂, Nb₂O₃, and WO₃, SiO, metal sulfides, metal nitrides, as well as carbon materials such as artificial black lead, natural black lead, graphite, soft carbon, and hard carbon. As the negative electrode active material, a metal that forms an alloy together with lithium can be used. A metal that produces an alloy together with lithium can be used. Examples of the metal that forms an alloy together with lithium include Mg, Si, Au, Ag, In, Ge, Sn, Pb, Al, and Zn.

### EXPERIMENT EXAMPLES

A conductive layer is laminated on a surface of a porous film to prepare a laminate, and this laminate is used as a separator to produce a secondary battery with the conductive layer placed on a negative electrode layer side. Effects of the secondary battery will be explained with reference to Experiment Examples.

### Experiment Example 1

### (Preparation of Separator)

A porous film (film thickness: 20 μm, porosity: 58%, air permeability: 92 sec/100 mL) was prepared. A copper conductive layer having a thickness of 0.08 μm was formed on one surface of the porous film by an RF sputtering method. The porous film having the copper conductive layer was punched out into a piece of 40 mm×50 mm size to prepare a separator.

### (Preparation of Positive Electrode Layer)

Acetylene black (AB) as an electron-conductive material, polyvinylidene fluoride (PVDF) as a binder, and polyvinylpyrrolidone (PVP) as a dispersant were premixed in N-methyl-2-pyrrolidone (NMP) as a dispersion solvent, and wet-mixed in a rotation-revolution type mixer to obtain a premixed slurry. Subsequently, Li₁Ni_{0.8}Co_{0.1}Mn_{0.1}O₂(NCM811) as a positive electrode active material and a pre-doping material were mixed with the obtained pre-mixed slurry, and the mixture was dispersed using a planetary mixer to obtain a positive electrode active material paste. NCM811 has a median diameter of 12 μm. Next, the obtained positive electrode active material paste was applied on an aluminum positive electrode current collector having no primer layer and then dried, which was pressurized using a roll press, and dried under vacuum at 120° C. to form a positive electrode plate having a positive electrode active material layer. The resulting positive electrode plate was punched out into a piece of 30 mm×40 mm size to prepare a positive electrode layer.

### (Preparation of Negative Electrode Layer)

A copper foil (electrical conductivity: 6.5×10⁶ S/cm) having a thickness of 10 μm and a lithium foil having a thickness of 20 μm were joined to each other to prepare a clad material. This clad material was punched out into a piece of 34 mm×44 mm size to prepare a negative electrode current collector.

### (Electrolytic Solution)

In 1,2-dimethoxyethane (DME), LiFSI was dissolved at a concentration of 4 mol/L to prepare an electrolytic solution.

### (Production of Lithium Metal Secondary Battery)

The copper conductive layer of the separator was overlaid on a surface of the negative electrode current collector on the lithium foil side, and the positive electrode active material layer of the positive electrode layer was overlaid on a surface opposed to the copper conductive layer side of the separator to prepare an electrode laminate with the negative electrode layer, the separator, and the positive electrode layer, laminated in this order. Subsequently, a positive electrode terminal was attached to the positive electrode current collector of the obtained electrode laminate via a positive electrode lead wire, and a negative electrode terminal was attached to the copper foil of the negative electrode current collector via a negative electrode lead wire. The laminate attached with the positive and negative electrode terminals was put into a laminated film bag, into which the electrolytic solution was put, and the laminated film bag was sealed to produce a lithium metal secondary battery.

### Experiment Example 2

A lithium metal secondary battery was produced in the same way as in Experiment Example 1 except that a zinc conductive layer having a thickness of 0.06 μm was formed instead of the copper conductive layer by an RF sputtering method in preparation of the separator.

### Experiment Example 3

A lithium metal secondary battery was produced in the same way as in Experiment Example 1 except that a carbon nanotube (CNT) conductive layer having a thickness of 2.1 μm was formed instead of the copper conductive layer by an application method in preparation of the separator. The carbon nanotube conductive layer was formed as follows. First, carbon nanotubes were added into N-methyl-N-pyrrolidinone (NMP) as a solvent such that a solid content concentration was 4% by mass, to which PVDF (#9300, manufactured by Kureha Corporation) was added as a binder such that a proportion of PVDF was 5 parts by mass with respect to 95 parts by mass of the carbon nanotube. Subsequently, the mixture was dispersed using a rotation-revolution type mixer at 1000 rpm for 10 minutes to prepare a coating liquid. The resulting coating liquid was applied to the surface of the porous film using a doctor blade and dried.

### Experiment Example 4

A lithium metal secondary battery was produced in the same way as in Experiment Example 1 except that a tin conductive layer having a thickness of 0.06 μm was formed instead of the copper conductive layer by an RF sputtering method in preparation of the separator.

### Comparative Experiment Example 1

A lithium metal secondary battery was produced in the same way as in Experiment Example 1 except that the copper conductive layer was not formed in preparation of the separator.

### Evaluation

An electrical conductivity, a surface resistivity, and a peel strength of the conductive layer of the separator prepared in each experiment example were measured by the following method. The results are presented in Table 1 together with the material, the coating method, and the thickness of the conductive layer in each separator. For each of the lithium metal secondary batteries produced in Experiment Examples and Comparative Experiment Example, the presence of short circuit was confirmed, and an increase rate of the lithium thickness was measured, according to the following method. The results are presented in Table 1.

### (Electrical Conductivity and Surface Resistivity of Conductive Layer)

The electrical conductivity and the surface resistivity were measured using a high-precision and high-performance resistivity meter (Loresta GP TCP-600, manufactured by Nittoseiko Analytech Co., Ltd.).

### (Peel Strength)

A conductive layer having a length of 5.0 cm and a width of 2.5 cm was press-bonded onto an adhesive tape having a width of 2.5 cm that had been press-bonded onto a fixed plate. Subsequently, one end of the conductive layer was folded back at 180 degrees and pulled up at a speed of 300 mm/min using an electric measurement stand (manufactured by IMADA Co., Ltd.) to peel the conductive layer from the porous film. A load required for the peeling of the conductive layer from the start to the termination of the peeling was measured using a digital force gauge (manufactured by IMADA Co., Ltd.). A value determined by dividing an average value of the measured load by the width of the adhesive tape was defined as the peeling strength.

### (Confirmation of Short-Circuit in Lithium Metal Secondary Battery)

The lithium metal secondary battery immediately after produced was allowed to stand at 25° C. for 24 hours. After the standing, the lithium metal secondary battery was subjected to a first charge and discharge cycle described below 3 times, then subjected to a second charge and discharge cycle described below 50 times, and the presence of short circuit in the lithium metal secondary battery was confirmed. If the charge capacity of the lithium metal secondary battery reached 105% or higher of the discharge capacity before charging, the battery was considered to cause a short circuit, and evaluated as “Yes”.

### (First Charge and Discharge Cycle)

The charge was performed under a condition that a constant-current charge was executed at a current value of 2.2 mA and up to 4.300 V, followed by a constant-voltage charge at a voltage value of 4.300 V for 60 minutes. The discharge was performed under a condition that a constant-current discharge was executed at a current value of 4 mA and up to 2.65 V. Between the discharge and the charge, the battery was allowed to stand for 30 minutes.

### (Second Charge and Discharge Cycle)

The charge was performed under a condition that a constant-current charge was executed at a current value of 74 mA and up to 3.823 V, at a current value of 52 mA and up to 4.051 V, at a current value of 46 mA and up to 4.173 V, and at a current value of 22 mA and up to 4.300 V, and then a constant-voltage charge was executed at a voltage value of 4.300 V for 90 minutes. The discharge was performed under a condition that a constant-current discharge was executed at a current value of 18 mA and up to 2.65 V. Between the discharge and the charge, the battery was allowed to stand for 30 minutes.

### (Increase Rate of Lithium Thickness in Lithium Metal Secondary Battery)

A thickness T1 (μm) of the negative electrode layer during initial charging, and a thickness T2 (μm) of the negative electrode layer (total thickness of the negative electrode current collector and the metallic lithium layer) during charging after 50 cycles were measured, and an increase rate T (μm/cycle) of the lithium thickness was calculated from the following equation. T(μm/cycle)=(T2−T1)/50

The thickness T1 (μm) of the negative electrode layer during the initial charging was measured as follows. The lithium metal secondary battery immediately after produced was allowed to stand at 25° C. for 24 hours. After the standing, the lithium metal secondary battery was subjected to a first charge and discharge cycle described above 3 times. Subsequently, the lithium metal secondary battery was charged by a process that a constant-current charge was executed at a current value of 14.7 mA and up to 4.300 V, followed by a constant-voltage charge at a voltage value of 4.300 V for 60 minutes. After charging, the lithium metal secondary battery was allowed to stand for 30 minutes and then disassembled, from which the negative electrode layer was taken out, and a thickness of the negative electrode layer was measured as thickness Ti.

A thickness T2 of the negative electrode layer during charge after 50 cycles was measured as follows. The lithium metal secondary battery immediately after produced was allowed to stand at 25° C. for 24 hours. After the standing, the lithium metal secondary battery was subjected to the first charge and discharge cycle 3 times, and then subjected to the second charge and discharge cycle 50 times. Subsequently, the lithium metal secondary battery was charged in such a way that a constant-current charge was executed at a current value of 14.7 mA and up to 4.300 V, followed by a constant-voltage charge at a voltage value of 4.300 V for 60 minutes. After charging, the lithium metal secondary battery was allowed to stand for 30 minutes and then disassembled, from which the negative electrode layer was taken out, and a thickness of the negative electrode layer was measured as thickness T2.

TABLE 1

| | | | | | | | Evaluation result for | |
|---|---|---|---|---|---|---|---|---|
| | | | | | | | secondary battery | |
| | | | | | | | | Increase |
| | Conductive Layer | | | | | | | rate in |
| | | | | Electrical | Surface | Peel | Presence | lithium |
| | | Coating | Thickness | conductivity | resistivity | strength | of short | thickness |
| | Material | method | (μm) | (S/cm) | (Ω/cm²) | (N/m) | circuit | (μm/cycle) |
| Experiment | Cu | RF | 0.08 | 3.8 × 10⁴ | 3.5 | 260 | No | 0.42 |
| Example 1 | | sputtering | | | | | | |
| | | method | | | | | | |
| Experiment | Zn | RF | 0.06 | 3.6 × 10³ | 200 | 270 | No | 0.50 |
| Example 2 | | sputtering | | | | | | |
| | | method | | | | | | |
| Experiment | CNT | Application | 2.10 | 1.0 × 10¹ | 83 | 0.5 | No | 0.56 |
| Example 3 | | method | | | | | | |
| Experiment | Sn | RF | 0.10 | 6.3 × 10² | 190 | 270 | No | 0.52 |
| Example 4 | | sputtering | | | | | | |
| | | method | | | | | | |
| Comparative | — | | | | | | Yes | 1.00 |
| Experiment | | | | | | | | |
| Example 1 | | | | | | | | |

As presented in Table 1, the lithium metal secondary batteries of Experiment Examples 1 to 4 including the separator having the conductive layer are less likely to cause a short circuit even through repeated charge and discharge and have a low increase rate of the lithium thickness, indicating that the metallic lithium layer (negative electrode active material layer) generated by charging is dense and has a high density. In contrast, the lithium metal secondary battery in Comparative Experiment Example 1 having the separator without the conductive layer is prone to short circuits through repeated charge and discharge and has a high increase rate of the lithium thickness, indicating that a coarse and low-density negative electrode active material layer is generated by charging.

### EXPLANATION OF REFERENCE NUMERALS

10 Electrode laminate
20 Positive electrode layer
21 Positive electrode current collector
22 Positive electrode active material layer
23 Positive electrode lead wire
24 Positive electrode terminal
30 Negative electrode layer
31 Negative electrode current collector
32 Lithium foil
33 Negative electrode lead wire
34 Negative electrode terminal
40 Elongated separator
41 Insulating porous film
41a Pore portion
42 Conductive layer
43 Insulating fold
43a End
43b Opening
44 Conductive fold
44a End
44b Opening
44c Extended portion
45 Electrode layer accommodating portion
46 First extension portion
47 Second extension portion
50 Exterior body
60 Chuck
100, 101, 200 Secondary battery

What is claimed is:

1. A secondary battery comprising an electrode laminate, an electrolytic solution, and an exterior body accommodating the electrode laminate and the electrolytic solution:
the electrode laminate having positive electrode layers, negative electrode layers, and an elongated separator;
the elongated separator comprising an insulating porous film and a conductive layer provided on one surface of the insulating porous film;
the elongated separator having an electrode layer accommodating portion with insulating folds folded along a length direction such that their surfaces on the insulating porous film side are inside and conductive folds folded along the length direction such that their surfaces on the conductive layer side are inside, alternately overlaid, and a first extension portion extending from one length-directional end portion of the electrode layer accommodating portion;
the positive electrode layers and the negative electrode layers being placed in the insulating folds and the conductive folds respectively so as to be opposed to each other; and
the first extension portion being wound around an outer surface of the electrode layer accommodating portion such that its surface on the insulating porous film side is outside.

2. The secondary battery according to claim 1, comprising a second extension portion extending from the other length-directional end portion of the electrode layer accommodating portion, wherein
the second extension portion extends such that the surface of the insulating porous film is in contact with ends of the conductive folds.

3. The secondary battery according to claim 1, wherein each conductive fold has an extended portion with a fold end extended, and
the extended portion is bent toward the positive electrode layer side.

4. The secondary battery according to claim 1, comprising: a positive electrode terminal electrically connected to the positive electrode layers and having at least a part exposed to the outside; and
a negative electrode terminal electrically connected to the negative electrode layers and having at least a part exposed to the outside, wherein
the positive electrode terminal and the negative electrode terminal are arranged along a direction orthogonal to the length direction of the elongated separator.

5. The secondary battery according to claim 1, wherein a negative electrode active material is metallic lithium.

6. A production method for a secondary battery, comprising: preparing an elongated separator having an electrode layer accommodating portion formed by folding, in a zigzag shape, a part of an elongated laminated sheet comprising an insulating porous film and a conductive layer placed on one surface of the insulating porous film in such a way that insulating folds folded along a length direction such that their surfaces on the insulating porous film side are inside and conductive folds folded along the length direction such that their surfaces on the conductive layer side are inside are alternately overlaid, and a first extension portion extending from one length-directional end portion of the electrode layer accommodating portion;
placing positive electrode layers and negative electrode layers on the insulating folds and the conductive folds respectively so as to be opposed to each other; and
winding the first extension portion around an outer surface of the electrode layer accommodating portion such that its surface on the insulating porous film side is outside.

7. A secondary battery comprising an electrode laminate, an electrolytic solution, and an exterior body accommodating the electrode laminate and the electrolytic solution:
the electrode laminate having positive electrode layers, negative electrode layers, and an elongated separator;
the elongated separator having an electrode layer accommodating portion with two or more folds folded in a zigzag shape along a length direction and an extension portion connected to a length-directional end portion of the electrode layer accommodating portion;
the positive electrode layers and the negative electrode layers being placed in the respective folds so as to be opposed to each other; and
the extension portion being wound around an outer surface of the electrode layer accommodating portion.
